(19) United States
(12) Patent Application Publication
(10) Pub. No.: US 2007/0075812 A1
(43) Pub. Date: Apr. 5, 2007

(54) Transformer

(75) Inventors: Shih-Chung Su, Taipei Hsien (TW); Kuan-Chih Chen, Taipei Hsien (TW)

Correspondence Address: POSZ LAW GROUP, PLC, 12040 SOUTH LAKES DRIVE, SUITE 101, RESTON, VA, 20191, US

(73) Assignee: LEADER ELECTRONICS, INC., Hsin-Tien City (TW)

(21) Appl. No.: 11/353,108

(22) Filed: Feb. 14, 2006

(30) Foreign Application Priority Data
Sep. 30, 2005 (TW) 094216906

(51) Int. Cl. H01F 27/02

(52) U.S. Cl. 336/83

(57) ABSTRACT

The transformer has a pair of cores, a winding assembly, a primary coil and a secondary coil. Each core has a center and an elliptical central core formed at the center. The winding assembly has a body and two mounting brackets. The body is a hollow elliptical column with two ends and has an outer surface and an elliptical mounting hole. The two mounting brackets are attached respectively to the two ends of the body, and each mounting bracket has a slot with a rounded edge and multiple pins. Since the central cores are elliptic, each central core may have a larger volume, such that the transformer may have a greater heat-absorbing capability, so transformer temperature rises slower. Furthermore, the winding assembly mounted on the central core is more stable, and even if the pins detach, the winding assembly will remain in position.

### BACKGROUND OF THE INVENTION

1. Field of the Invention

The present invention relates to a transformer and particularly to a transformer having elliptical central cores.

2. Description of Related Art

Transformers are installed on PC boards of electronic devices to transform input voltage to suit the electronic devices. With reference to FIGS. 5 and 6, a conventional transformer comprises a pair of cores (30), a winding assembly (40), a primary coil (not shown) and a secondary coil (not shown).

Each core (30) has a center, an outer surface, a central core (31) and an outer core (32). The central core (31) is cylindrical and is formed in the center of the core (30). The outer core (32) is formed around the outer surface and has two ends and two openings. The openings are defined respectively at the two ends.

The winding assembly (40) comprises a body (41) and two mounting brackets (44). The body (41) is a hollow cylindrical column with a center, a top, a bottom, two flanges (42), an outer surface and a mounting hole (43). The two flanges (42) radially protrude respectively out from the top and the bottom. The outer surface is defined between the two flanges (42). The mounting hole (43) is formed longitudinally through the center of the body (41) and has two openings. The openings correspond to and are mounted on the central core (31).

The two mounting brackets (44) are attached to the two ends of the body (41), which are located respectively at the two openings of the outer core (32) diametrically opposite to each other. Each mounting bracket (44) has a top surface, a bottom surface, a longitudinal axis, a slot (441) and multiple pins (440). The slot (441) is formed longitudinally in the mounting bracket (44) and has a square edge (442) defined at the top surface of the mounting bracket (44). The pins (440) are mounted in and protrude from the bottom surface of the mounting bracket (44) to mount the transformer on a PC board.

The primary coil (not shown) and the secondary coil (not shown) are wound on the outer surface of the winding assembly (40). Each coil has a pair of ends. The pairs of ends pass respectively through the slots (441) and may connect respectively to pins (440) of the mounting brackets (44). When electricity passes through the conventional transformer, heat is generated due to the coil resistance. The heat is usually absorbed by the central core (31) and finally raises the temperature of the transformer.

Since the central core (31) of the conventional transformer is cylindrical, the volume of each central core (41) is usually limited by the size of the transformer, which reduces the heat absorbing capability of the conventional transformer and causes the temperature to rise quicker. Furthermore, if the pins (440) detach, the winding assembly (40) mounted on the central core (41) may rotate and damage other electronic elements on the PC board.

Furthermore, the pairs of ends of the primary coil (not shown) and the secondary coil (not shown) passing respectively through the slot (441) must bend at a sharp angle because of the square edge (442) of the slot (441). This makes the coil winding on the outer surface uneven, which produces electromagnetic interference that reduces the overall efficiency of the conventional transformer.

To overcome the shortcomings, the present invention provides a transformer to obviate or mitigate the aforementioned problems.

### SUMMARY OF THE INVENTION

The transformer in accordance with the present invention is provided to keep the temperature of the transformer from rising quickly and reduce electromagnetic interference.

To achieve the objective, the transformer in accordance with the present invention comprises a pair of cores, a winding assembly, a primary coil and a secondary coil.

Each core is an elliptical column and has a center and an elliptical central core formed at the center.

The winding assembly has a body and two mounting brackets. The body is a hollow elliptical column with two ends and has an outer surface and a mounting hole. The mounting hole is elliptical, is formed longitudinally through the center and has two openings.

The two mounting brackets are attached respectively to the two ends of the body, and each mounting bracket has a slot and multiple pins.

Because the central cores are elliptic, each central core may have larger the volume such that the transformer may have a greater heat-absorbing capability so transformer temperature rises slower. Furthermore, the winding assembly mounted on the central core is more stable, and even if the pins detach, the winding assembly will remain in position.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a transformer in accordance with the present invention;

FIG. 2 is an exploded perspective view of the transformer in FIG. 1;

FIG. 3 is a bottom view of the transformer in FIG. 1 with internal parts shown in phantom lines;

FIG. 4 is a side view in partial section of the transformer in FIG. 1;

FIG. 5 is an enlarged perspective view of the bottom part of a winding assembly of a conventional transformer in accordance with the prior art;

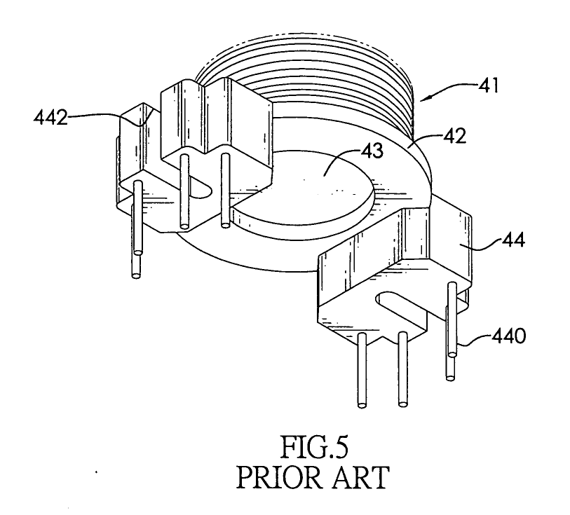

FIG. 6 is a bottom view of a conventional transformer using the winding assembly in FIG. 5 with internal parts shown in phantom lines;

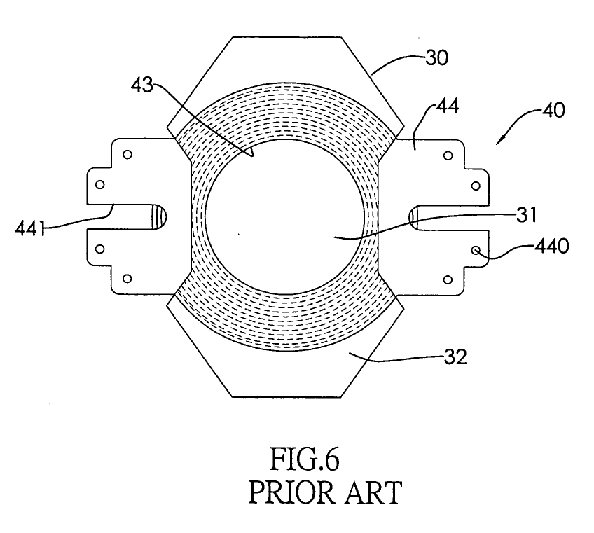

### DETAILED DESCRIPTION OF THE PREFERRED EMBODIMENT

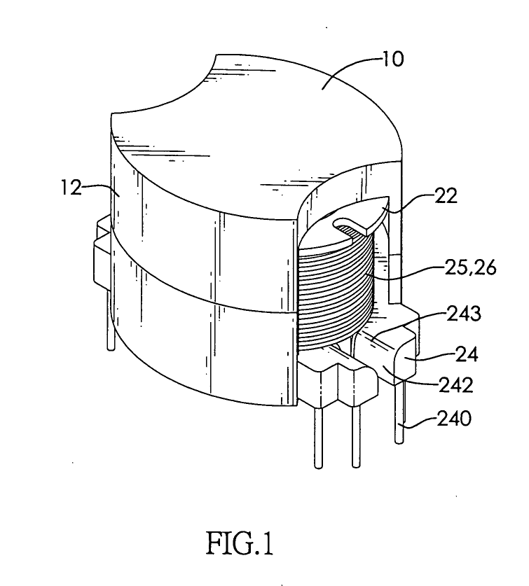

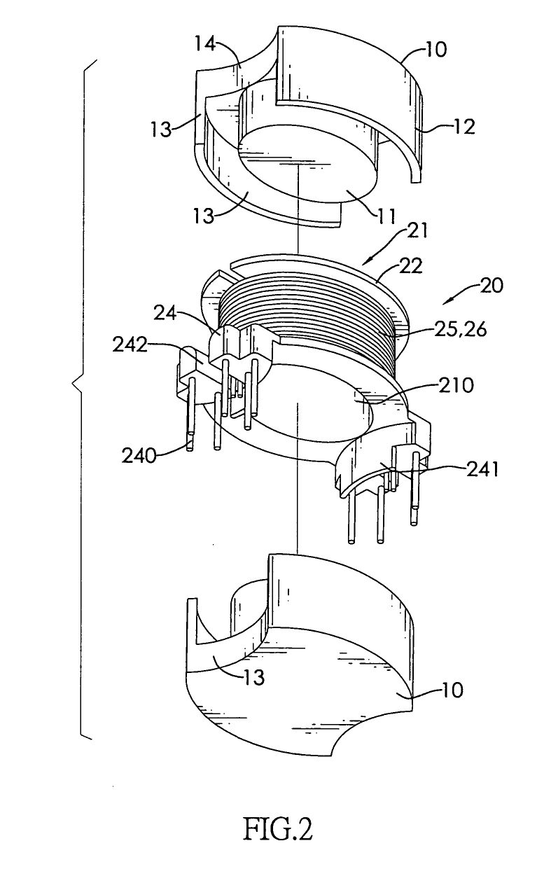

With reference to FIG. 1 and 2, a transformer in accordance with the present invention can be mounted on a PC board to regulate voltage of input current and comprises a pair of cores (10) and a winding assembly (20)

Each core (10) is elliptical and has a center, a major axis, an outer fringe, a central core (11) and an outer core (12). The main axis has two ends. The central core (11) is elliptical and is formed in the center. The outer core (12) is formed along the outer surface and has two concave recesses (13). The concave recesses (13) are defined respectively at the ends of the major axis.

The winding assembly (20) comprises a body (21), two mounting brackets (24), a primary coil (25) and a secondary coil (26). The body (21) is formed as a hollow elliptical column with a center, a top, a bottom and two ends and has two flanges (22), an outer surface (23) and a mounting hole (210). The two flanges (22) protrude radially out respectively from the top and the bottom. The outer surface (23) is defined between the two flanges (22). The mounting hole (210) is elliptical, is formed longitudinally through the center and has two openings corresponding to and mounted on the central cores (11) of the two cores (10).

The two mounting brackets (24) are attached respectively to the two ends of the body (21) and protrude respectively beyond the two concave recesses (13) of the outer core (12). Each mounting bracket (24) has a top surface, a bottom surface, a longitudinal axis, a slot (242), multiple pins (240) and an optional spacer (241). The slot (242) is formed parallel to the longitudinal axis and has a rounded edge (243). The rounded edge (243) is defined at the top surface of the mounting bracket (24). The pins (240) are attached to and protrude from the bottom surfaces of the mounting brackets (24) to connect the transformer to a PC board. A different number of pins (240) are attached to each mounting bracket (24) to assist in identifying the pairs of ends for the primary and secondary coils. The spacers (241) are formed respectively on and protrude from the bottom surfaces of the mounting brackets (24) and separate the transformer from the PC board.

The primary coil (25) is wound on the central cores (11) of the two cores (10) and has a pair of ends. The ends extend respectively over the rounded edges (243) and through the slot (242) of one mounting bracket (24) and may connect to the pins (240) one the mounting brackets (24).

The secondary coil (26) is wound on the central cores (11) of the two cores (10) and has a pair of ends. The ends extend respectively over the rounded edges (243) and through the slots (242) of the other mounting bracket (24) and may connect to pins (240) on the mounting brackets (24)

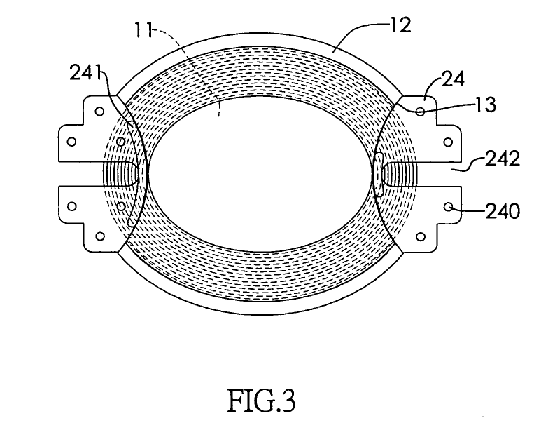

With further reference to FIG. 3, the central cores (11) being elliptical allows the volume of each central core (11) of the transformer to be larger than a conventional transformer. Consequentially, the transformer may have a greater heat-absorbing capability so transformer temperature will rise slower. Furthermore, the winding assembly (20) mounted on the central core (11) is more stable, and even if the pins (240) detach, the winding assembly (20) will remain in position.

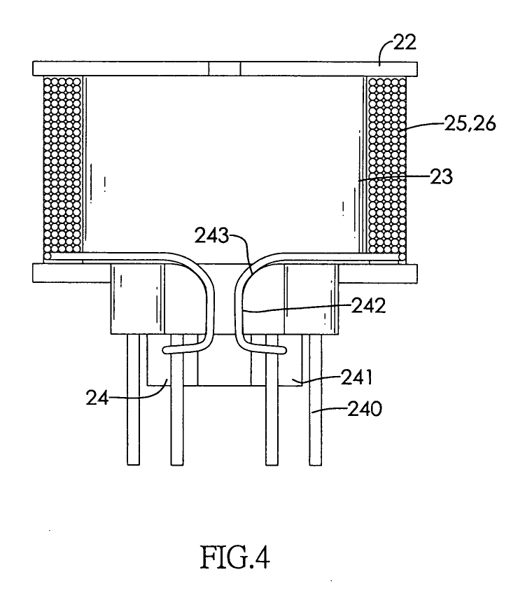

With further reference to FIG. 4, the ends of the coils extending over the rounded edges (243) of the slots (242) allow the primary coil (25) and the secondary coil (26) to be wound more evenly on the outer surface (23) of the winding assembly (20) to effectively prevent electromagnetic interference.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A transformer comprising:
a pair of cores, each core being elliptical and having
a center,
a major axis having two ends,
an outer fringe,
a central core being elliptical and being formed in the center; and
an outer core being formed along the outer surface and having two concave recesses defined respectively at the ends of the major axis;
a winding assembly comprising
a body formed as a hollow elliptical column with a center, a top, a bottom and two ends and having
two flanges protruding radially out respectively from the top and the bottom;
an outer surface defined between the two flanges; and
a mounting hole being elliptical, formed longitudinally through the center and having two openings corresponding to and mounted on the central cores of the two cores; and
two mounting brackets attached respectively to the two ends of the body and protruding respectively beyond the two concave recesses of one of the outer cores, and each mounting bracket having
a top surface;
a bottom surface;
a longitudinal axis;
a slot formed parallel to the longitudinal axis and having a rounded edge defined on the top surface of the mounting bracket; and
multiple pins attached and protruding from the bottom surface;
a primary coil wound on the outer surface of the winding assembly and having a pair of ends extending respectively over the rounded edges and through the slot of one mounting bracket; and
a secondary coil wound on the outer surface of the winding assembly and having a pair of ends extending respectively over the rounded edges through the slot of the other mounting bracket.

2. The transformer as claimed in claim 1, wherein a different number of pins are attached to each mounting bracket.

3. The transformer as claimed in claim 1, wherein each mounting bracket further has a spacer, and the spacers are formed respectively on and protrude from the bottom surfaces of the mounting brackets.
